(19) United States
(12) Patent Application Publication
(10) Pub. No.: US 2009/0117333 A1
(43) Pub. Date: May 7, 2009

(54) METHOD OF MANUFACTURING DISPLAY DEVICE AND DISPLAY DEVICE THEREFROM

(76) Inventors: Byeong-Jin Lee, Gyeonggi-do (KR); Hong-sick Park, Gyeonggi-do (KR); Hong-long Ning, Gyeonggi-do (KR); Chang-oh Jeong, Gyeonggi-do (KR); Yang-ho Bae, Seoul (KR); Pil-sang Yun, Seoul (KR); Sung-hen Cho, Seoul (KR); Ki-Yong Song, Seoul (KR); Seung-jae Jung, Seoul (KR); Byeong-beom Kim, Gyeonggi-do (KR)

Correspondence Address: Haynes and Boone, LLP;IP Section, 2323 Victory Avenue, SUITE 700, Dallas, TX, 75219, US

(21) Appl. No.: 12/198,746

(22) Filed: Aug. 26, 2008

(30) Foreign Application Priority Data
Nov. 1, 2007 (KR) 10-2007-0111174

(51) Int. Cl. B32B 3/02; B05D 5/12

(52) U.S. Cl. 428/156; 216/18

(57) ABSTRACT

A method of manufacturing a display device includes: forming an auxiliary layer including at least one of metal and a metal oxide on an insulating substrate; forming a photoresist layer pattern partially exposing the auxiliary layer on the auxiliary layer; forming a trench on the insulating substrate by etching the exposed auxiliary layer and the insulating substrate under the exposed auxiliary layer; forming a seed layer including a first seed layer disposed on the photoresist layer pattern and a second seed layer disposed in the trench; removing the photoresist layer pattern and the first seed layer by lifting off the photoresist layer pattern; removing the auxiliary layer remaining on the insulating substrate after lifting off the photoresist layer pattern; and forming a main wiring layer on the second seed layer by electroless plating.

### CROSS-REFERENCE TO RELATED APPLICATIONS

This application claims priority under 35 U.S.C. §119 to Korean Patent Application No. 10-2007-0111174, filed on Nov. 1, 2007 in the Korean Intellectual Property Office, the contents of which are incorporated herein by reference in their entirety.

### BACKGROUND

1. Technical Field

Apparatuses and methods consistent with the present invention generally relate to a method of manufacturing a display device and a display device therefrom, more particularly, to a method of manufacturing a display device where wire resistance is reduced and a display device therefrom.

2. Description of Related Art

A flat panel display device, such as a liquid crystal display (LCD), plasma display panel (PDP), electrophoretic display, and organic light emitting diode (OLED), are widely used.

The display device includes a thin film transistor, which is connected to a gate line and a data line insulatingly intersecting each other.

The gate line is applied with a scan signal (gate signal) such as a gate on voltage and gate off voltage, and the data line is applied with a display signal (data signal).

As the display device size increases, wires such as a gate line and data line increase in length. When the wires become longer, resistance increases. Thus, a low-resistance wire is preferable to properly transmit a signal.

The low-resistance wire may be formed by increasing the thickness or width of the wire. However, when the thickness of the wire is increased, another wire formed on the wire may be disconnected due to a step difference. Further, when the width of the wire is increased, an aperture ratio is reduced.

### SUMMARY

Accordingly, it is an aspect of embodiments of the present invention to provide a method of manufacturing a display device having wiring with low resistance of which an upper wire is not disconnected and which does not cause the decrease of an aperture ratio.

Another aspect of embodiments of the present invention is to provide a display device having wiring with low resistance of which an upper wire is not disconnected and which does not cause the decrease of an aperture ratio.

Additional aspects of embodiments of the present invention will be set forth in part in the description which follows and, in part, will be obvious from the description, or may be learned by practice of the present invention.

The foregoing and/or other aspects of the present invention may be achieved by providing embodiments of a method of manufacturing a display device comprising: forming an auxiliary layer including at least one of metal and a metal oxide on an insulating substrate; forming a photoresist layer pattern partially exposing the auxiliary layer on the auxiliary layer; forming a trench on the insulating substrate by etching the exposed auxiliary layer and the insulating substrate under the exposed auxiliary layer; forming a seed layer including a first seed layer disposed on the photoresist layer pattern and a second seed layer disposed in the trench; removing the photoresist layer pattern and the first seed layer by lifting off the photoresist layer pattern; removing the auxiliary layer remaining on the insulating substrate after lifting off the photoresist layer pattern; and forming a main wiring layer on the second seed layer by electroless plating.

The main wiring layer may be formed substantially only in the trench.

The metal of the auxiliary layer may comprise at least one of molybdenum (Mo), a molybdenum alloy, chrome (Cr), copper (Cu), a copper alloy, aluminum (Al), an aluminum alloy, silver (Ag), and a silver alloy.

The metal oxide of the auxiliary layer may comprise at least one of an indium-tin-oxide and indium-zinc-oxide.

The auxiliary layer may have a thickness of 50 Å to 3000 Å.

The seed layer may comprise at least one of molybdenum (Mo), a molybdenum alloy, chrome (Cr), copper (Cu), a copper alloy, a copper oxide, aluminum (Al), an aluminum alloy, silver (Ag), a silver alloy, titanium (Ti), and a titanium alloy.

The seed layer may comprise a lower copper oxide layer and an upper copper layer, and the main wiring layer comprises copper.

The second seed layer may be not substantially removed when removing the auxiliary layer.

The first seed layer and the second seed layer may be separated.

An undercut may be formed under the photoresist layer pattern when forming the seed layer.

The method may further comprise additionally etching the auxiliary layer after etching the insulating substrate and before forming the seed layer.

The additional etching may be carried out by wet etching.

The undercut may be formed both on the auxiliary layer and on the insulating substrate.

The undercut formed on the auxiliary layer may be formed when etching the insulating substrate.

The etching the insulating substrate may be carried out by wet etching.

The main wiring layer may comprise at least one of copper and silver.

The main wiring layer may have a thickness of 0.3 μm to 2 μm.

The insulating substrate may comprise a glass substrate.

The foregoing and/or other aspects of embodiments of the present invention may be achieved by providing a method of manufacturing a display device comprising: forming an auxiliary layer including metal on an insulating substrate; forming a photoresist layer pattern on the auxiliary layer; etching the auxiliary layer using the photoresist layer pattern as a mask to expose the insulating substrate; etching the exposed insulating substrate to form a trench on the insulating substrate and to form an undercut under the photoresist layer pattern; forming a seed layer including a first seed layer disposed on the photoresist layer pattern and a second seed layer disposed in the trench and separated from the first seed layer by the undercut; removing the photoresist layer pattern and the first seed layer by lifting off the photoresist layer pattern; removing the auxiliary layer on the insulating substrate after lifting off the photoresist layer pattern; and forming a main wiring layer on the second seed layer by electroless plating.

The auxiliary layer may comprise at least one of molybdenum (Mo), a molybdenum alloy, chrome (Cr), copper (Cu), a copper alloy, aluminum (Al), an aluminum alloy, silver (Ag), and a silver alloy.

The seed layer may comprise a lower copper oxide layer and an upper copper layer, and the main wiring layer comprises copper.

The foregoing and/or other aspects of embodiments of the present invention may be achieved by providing a display device comprising: an insulating substrate where a trench is formed; and a wiring layer disposed in the trench and including a copper oxide layer directly contacting with the insulating substrate and a copper layer disposed on the copper oxide layer.

The copper layer may have a thickness of 0.3 μm to 2 μm.

The copper layer may be disposed substantially in the trench.

### BRIEF DESCRIPTION OF DRAWINGS

The above and/or other aspects of embodiments of the present invention will become apparent and more readily appreciated from the following description, taken in conjunction with the accompanying drawings, in which:

FIG. 1 is an arrangement view of a display device according to a first exemplary embodiment of the present invention;

FIG. 2 is a cross-sectional view of the display device taken along line II-II in FIG. 1;

FIGS. 3A to 3H are cross-sectional views illustrating a method of manufacturing the display device according to the first exemplary embodiment of the present invention;

FIG. 4 illustrates another method of manufacturing the display device according to the first exemplary embodiment of the present invention;

FIGS. 5A to 5D are illustrate still another method of manufacturing the display device according to the first exemplary embodiment of the present invention; and

FIG. 6 is a cross-sectional view of a display device according to a second exemplary embodiment of the present invention.

### DETAILED DESCRIPTION

Reference will now be made in detail to the embodiments of the present invention, examples of which are illustrated in the accompanying drawings, wherein like reference numerals refer to like elements throughout. Like elements will be representatively described in the first exemplary embodiment, but not repeatedly explained in other exemplary embodiments. The embodiments are described below so as to explain the present invention by referring to the figures.

In the following embodiments, a display device will be described with an LCD as an example, illustrating an LCD panel as a display panel, but the present invention is not limited thereto. Other display devices, such as an OLED, PDP, and electrophoretic display, would also be within the scope of these embodiments.

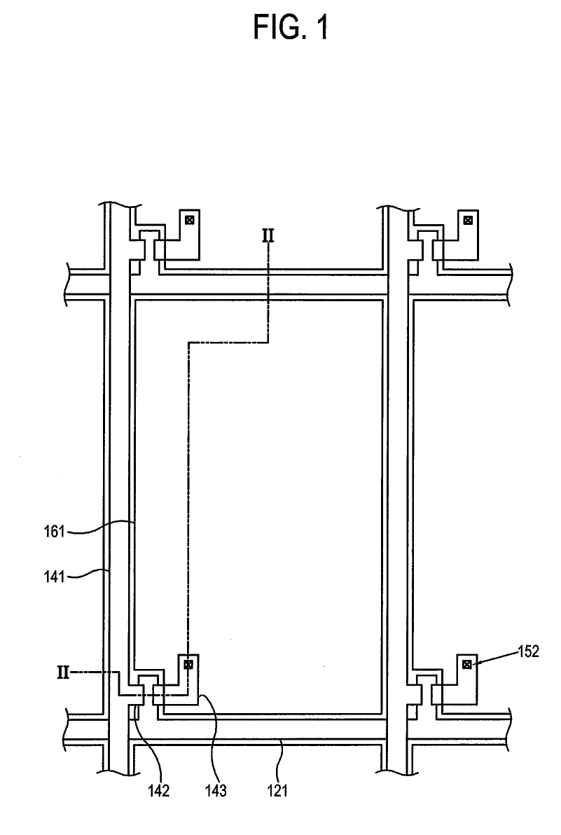

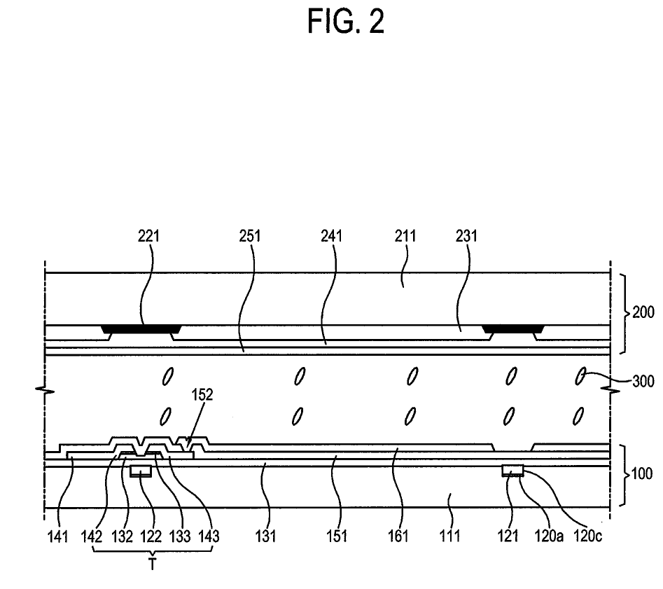

Hereinafter, a display device according to a first exemplary embodiment of the present invention will be described with reference to FIGS. 1 and 2.

A display device 1 includes a first substrate 100 where TFTs are formed, a second substrate 200 facing the first substrate 100, and a liquid crystal layer 300 disposed between the substrates 100 and 200.

First of all, the first substrate 100 is described.

A gate wiring 121 and 122 is formed on a first insulating substrate 111 made of glass, quartz, or plastic. The gate wiring 121 and 122 may be a metal single layer or a metal multilayer.

The gate wiring 121 and 122 includes a gate line 121 extending transversely and a gate electrode 122 connected to the gate line 121.

The gate wiring 121 and 122 may further include a storage capacity line (not shown) to form storage capacity.

The gate wiring 121 and 122 is made of a double layer of a lower seed layer 120a and an upper main wiring layer 120c. The seed layer 120a may comprise one of molybdenum (Mo), molybdenum alloys, chrome (Cr), copper (Cu), copper alloys, aluminum (Al), aluminum alloys, silver (Ag), silver alloys, titanium (Ti), and titanium alloys, in particular copper oxides. The molybdenum alloys may be provided as MoN and MoNb, and the copper alloys may be provided as CuMo. The main wiring layer 120c may be made of copper or silver.

The seed layer 120a has a thickness of 100 Å to 1000 Å. When made of copper alloys, it may have a thickness of 300 Å to 500 Å. The main wiring layer 120c may have a thickness of 0.3 μm to 2 μm.

Here, most part of the gate wiring 121 and 122 is formed in a trench formed on the insulating substrate 111. In other words, the main wiring layer 120c is substantially, for example 90% or more, disposed within the trench. Thus, the depth of the trench is almost equal to the total thickness of the seed layer 120a and main wiring layer 120c.

As the gate wiring 121 and 122 is thick, it may favorably realize low resistance. In particular, when the main wiring layer 120c is made of copper with low resistance, resistance value may be further lowered.

Since the gate wiring 121 and 122 is thick, it may obtain a desired low resistance value even when the width thereof is decreased. Accordingly, an aperture ratio may be increased by decreased width of the gate wiring 121 and 122.

A gate insulating layer 131 made of silicon nitride (SiNx) or the like is formed on the first insulating substrate 111 to cover the gate wiring 121 and 122. The gate wiring 121 and 122 is comparatively thick, and its most part is disposed within the trench. Thus, the gate insulating layer 131 is almost flat even on the gate wiring 121 and 122 without being stepped.

A semiconductor layer 132 made of amorphous silicon is formed on the gate insulating layer 131 over the gate electrode 122. An ohmic contact layer 133 made of hydrogenated amorphous silicon highly doped with n-type impurities is formed on the semiconductor layer 132. The ohmic contact layer 133 is excluded in a channel area between a source electrode 142 and a drain electrode 143.

A data wiring 141, 142, and 143 is formed on the ohmic contact layer 133 and the gate insulating layer 131. The data wiring 141, 142, and 143 may be a metal single layer or a metal multilayer. The data wiring 141, 142, and 143 includes a data line 141 formed lengthwise to intersect the gate line 121 to form a pixel, the source electrode 142 branched from the data line 141 and extended over the ohmic contact layer 133, the drain electrode 143 separated from the source electrode 142 and formed on a portion of the ohmic contact layer 133 opposite to the source electrode 142.

As the gate insulating layer 131 is almost levelly formed even on the gate wiring 121 and 122, the profile of the data wiring 141, 142, and 143 is influenced only by the thickness of the semiconductor layer 132 and the thickness of the ohmic contact layer 133 not by the gate wiring 121 and 122. Thus, the disconnection of the data wiring 141, 142, and 143 in an overlapping region with the gate wiring 121 and 122 owing to a rapid profile of the data wiring 141, 142, and 143 less arises.

A passivation layer 151 is formed on the data wiring 141, 142, and 143 and a portion of the semiconductor layer 132 not covered with the data wiring. The passivation layer 151 is formed with a contact hole 152 to expose the drain electrode 143.

A pixel electrode 161 is formed on the passivation layer 151. The pixel electrode 161 is generally made of a transparent conductive material such as indium tin oxide (ITO) or indium zinc oxide (IZO). The pixel electrode 161 is connected with the drain electrode 143 through the contact hole 152.

Next, the second substrate 200 will be described.

A black matrix 221 is formed on a second insulating substrate 211. The black matrix 221 is disposed between red, green and blue filters to divide the filters and prevent light from being irradiated directly to the TFTs on the first substrate 100.

The black matrix 221 is typically made of a photoresist organic material including a black pigment. The black pigment may be carbon black.

A color filter layer 231 includes red, green and blue filters which are alternately disposed and separated by the black matrix 221. The color filter layer 231 endows colors to light irradiated from a backlight unit (not shown) and passing through the liquid crystal layer 300. The color filter layer 231 is generally made of a photoresist organic material.

An overcoat layer 241 is formed on the color filter layer 231 and the black matrix 221 not covered with the color filter 231. The overcoat layer 241 provides a planar surface and protects the color filter layer 231. The overcoat layer 241 may be made of a photoresist acrylic resin.

A common electrode 251 is formed on the overcoat layer 241. The common electrode 251 is made of a transparent conductive material such as ITO or IZO. The common electrode 251 forms an electric field along with the first electrode 161 of the first substrate 100 to drive the liquid crystal layer 300.

Liquid crystal molecules in the liquid crystal layer 300 are varied in alignment according to the electric field formed by the common electrode 251 and the pixel electrode 161. Light passing through the liquid crystal layer 300 has a transmittance determined depending on the alignment of the liquid crystal molecules of the liquid crystal layer 300.

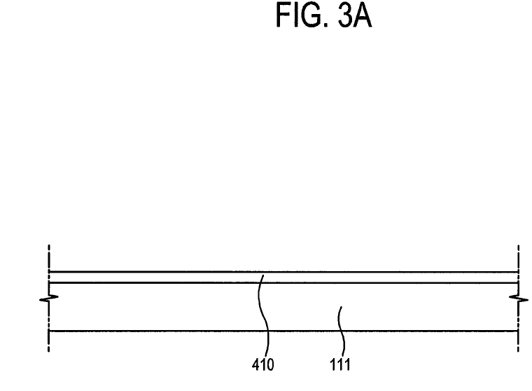

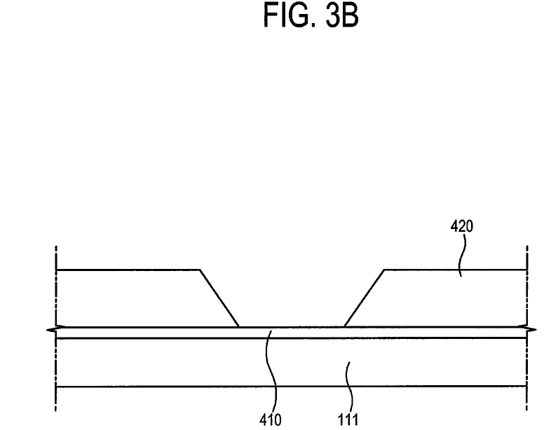

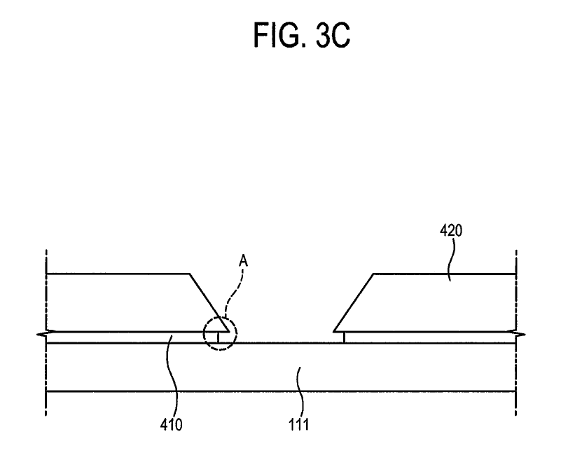

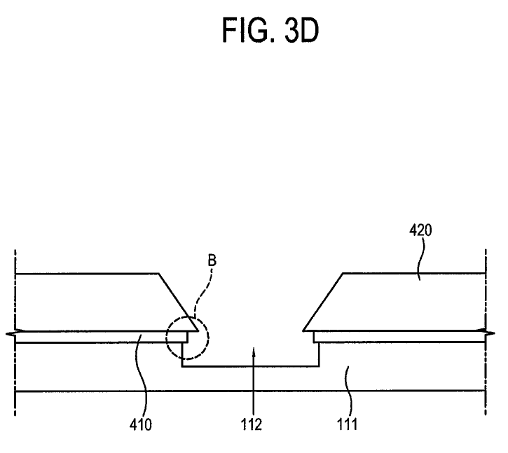

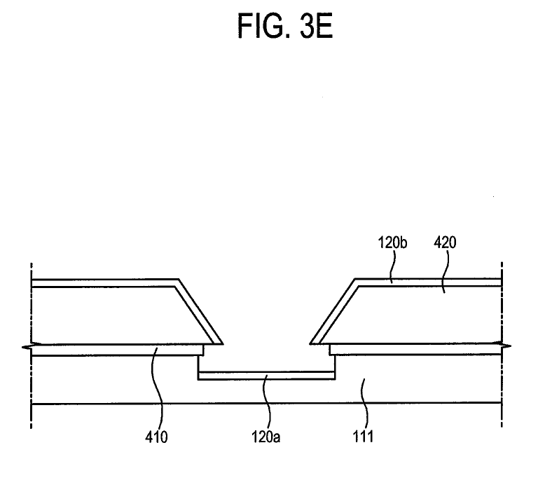

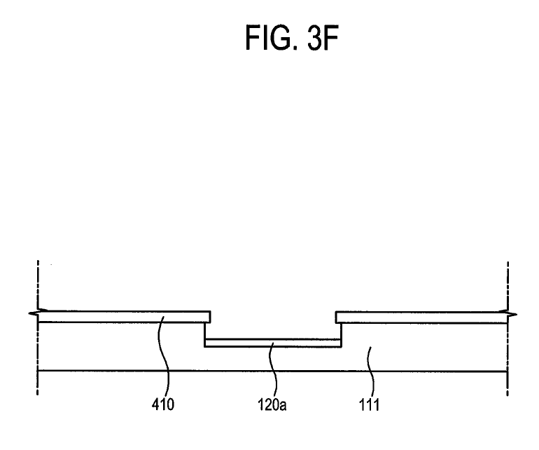

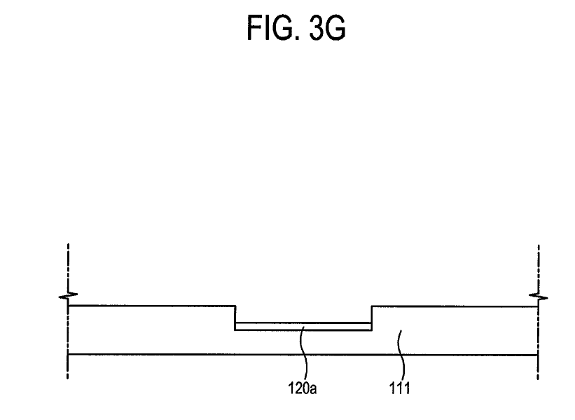

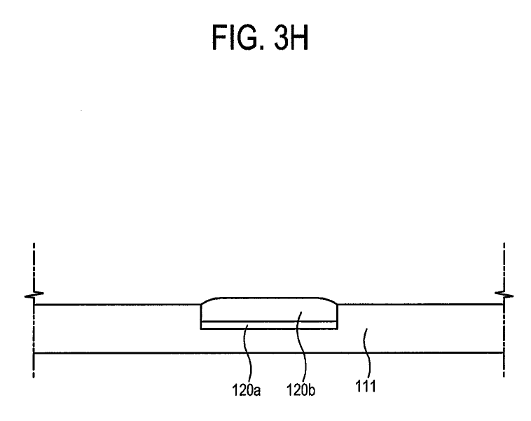

Hereinafter, a method of manufacturing the display device according to the first exemplary embodiment will be described with reference to FIGS. 3A to 3H. In the following description, a method of forming the gate wiring 121 and 122 will be made only. The following processes after forming the gate wiring 121 and 122 are carried out with a known technology, which will not be explained.

Referring to FIG. 3A, an auxiliary layer 410 is formed on the insulating substrate 111. The auxiliary layer 410 stabilizes a photoresist layer pattern 420 (see FIG. 3B) to be formed thereon.

The photoresist layer pattern 420 is not adequately adhered to the insulating substrate 111 so that it may not stably keep in shape during the etching process of thin films, in particular etching the insulating substrate 111. The auxiliary layer 410 is disposed between the insulating substrate 111 and the photoresist layer pattern 420 to stabilize the photoresist layer pattern 420 during the etching process.

The auxiliary layer 410 may be made of metal or a metal oxide. The metal includes at least one of molybdenum (Mo), molybdenum alloys, chrome (Cr), copper (Cu), copper alloys, aluminum (Al), aluminum alloys, silver (Ag), and silver alloys, and the metal oxide may be one of an indium-tin-oxide or indium-zinc-oxide.

The auxiliary layer 410 may have a thickness of 50 Å to 3000 Å and be formed by sputtering.

Referring to FIG. 3B, the photoresist layer pattern 420 is formed on the auxiliary layer 410. The photoresist layer pattern 420 may be formed by coating, exposing, developing, and baking a photoresist material. Here, both negative-type and positive-type photoresist material may be used.

The photoresist layer pattern 420 exposes the auxiliary layer 410 at a position where the gate wiring 121 and 122 is to be formed.

Referring to FIG. 3C, the auxiliary layer 410 is etched using the photoresist layer pattern 420 as a mask. Dry etching or wet etching is carried out to remove the exposed auxiliary layer 410. In this process, the auxiliary layer 410 is partially removed under an end portion of the photoresist layer pattern 420 to form an undercut (area A).

Referring to FIG. 3D, a portion of insulating substrate 111 which is not covered with the auxiliary layer 410 is etched to form a trench 112.

In this process, the auxiliary layer 410 is partially etched, and the insulating substrate 111 is partially removed under an end portion of the auxiliary layer 410. Accordingly, an undercut (area B) is formed in the auxiliary layer 410 and the insulating substrate 111 under the photoresist layer pattern 420.

That is, a distance between the separate photoresist layer patterns 420 is longer than a distance between the separate auxiliary layers 410. Further, the width of the trench 112 is longer than the distance between the separate auxiliary layers 410.

Etching the insulating substrate 111 may be carried out by dry etching or wet etching, wherein wet etching of isotropic etching is used to adequately form an undercut.

In the process of etching the insulating substrate 111, the photoresist layer pattern 420 may be suffer a partial loss but maintained in shape, for which is stabilized by the auxiliary layer 410.

Referring to FIG. 3E, seed layers 120a and 120b are formed. The seed layers 120a and 120b includes the seed layer 120a formed in the trench 112 and a seed layer 120b formed on the photoresist layer pattern 420. The seed layers 120a and 120b may be formed by sputtering.

The seed layers 120a and 120b are separated from each other by the undercut formed under the photoresist layer pattern 420. That is, the seed layer 120a formed in the trench 112 and the seed layer 120b formed on the photoresist layer pattern 420 are not connected with each other.

Referring to FIG. 3F, the photoresist layer pattern 420 is lifted off to be removed. Here, the seed layer 120b on the photoresist layer pattern 420 is removed together, but the seed layer 120a in the trench 112 is not removed. This is because the seed layer 120b on the photoresist layer pattern 420 and the seed layer 120a in the trench 112 are separated by the undercut.

After lifting off the photoresist layer pattern 420, the seed layer 120a in the trench 112 and the auxiliary layer 410 disposed outside the trench 112 are only left on the insulating substrate 111.

Referring to FIG. 3G, the auxiliary layer 410 remaining on the insulating substrate 111 is removed. The auxiliary layer 410 is removed by etching, wherein the seed layer 120a should be left. Thus, the seed layer 120a is formed of material which is not removed when etching the auxiliary layer 410. In other words, the seed layer 120a and the auxiliary layer 410 have etching selectivity. Accordingly, when the auxiliary layer 410 is made of molybdenum, the seed layer 120a may be made of titanium or titanium alloys. When the auxiliary layer 410 is made of chrome, the seed layer 120a may be made of aluminum.

Thereafter, the seed layer 120a in the trench 112 is only left on the insulating substrate 111.

Referring to FIG. 3H, a main wiring layer 120c may be formed by electroless plating or the like. In electroless plating, the main wiring layer 120c is formed only on the seed layer 120a so that the gate wiring 121 and 122 are mostly disposed in the trench 112.

In forming the main wiring layer 120c, the deposition time of electroless plating or the like is adjusted to form the main wiring layer 120c not to be protruded from the trench 112 or not to be lower than the trench 112. As necessary, a process of removing the main wiring layer 120c protruding from the trench 112 may further be provided.

Accordingly, the gate wiring 121 and 122 being thick and not substantially (or only slightly) protruding from the insulating substrate 111 is formed.

Meanwhile, when the wiring is increased in thickness, it may not obtain a desired shape. According to the present embodiment, the gate wiring 121 and 122 has a shape determined depending on the shape of trench 112. Thus, the deformation of the gate wiring 121 and 122 by being out of the shape of the trench 112 is not generated.

In the present embodiment, etching is not carried out on the main wiring layer 120c. Thus, an adequate etching solution for metal used for the main wiring layer 120c, in particular copper, is not required.

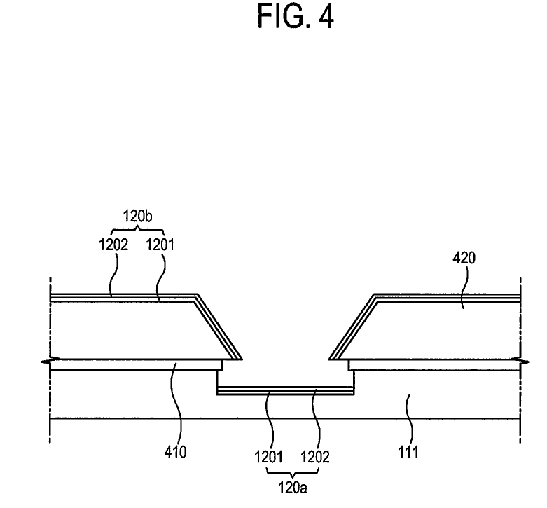

Hereinafter, another method of manufacturing the display device according to the first exemplary embodiment of the present invention will be described with reference to FIG. 4.

FIG. 4 illustrates a process corresponding to FIG. 3E where seed layers 120a and 120b are formed, and the former and following processes are omitted in description.

The seed layers 120a and 120b each include a lower copper oxide layer 1201 and an upper copper layer 1202. The copper oxide layer 1201 has a thickness of 300 Å to 500 Å, and the copper layer 1202 has a thickness of 500 Å to 1000 Å.

The lower copper oxide layer 1202 stabilizes the connection of an insulating substrate 111 and the copper layer 1202.

The upper copper layer 1202 reduces the stress between the seed layers 120a and 120b and a main wiring layer 120c to be formed. When the main wiring layer 120c is made of copper, both of the main wiring layer 120c and the copper layer 1202 include copper to have the same coefficient of thermal expansion. Thus, a stress due to a difference between coefficients of thermal expansion of the main wiring layer 120c and the seed layers 120a and 120c is not generated in forming the main wiring layer 120c.

Meanwhile, as the upper copper layer 1202 is made of the same copper as the main wiring layer 120c, it may not appear to be discriminated as a separate layer after forming the main wiring layer 120c.

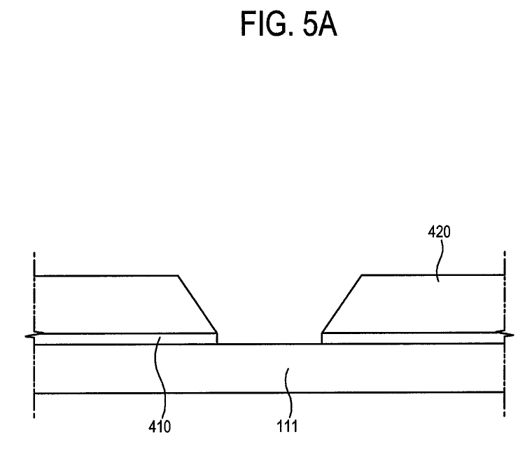

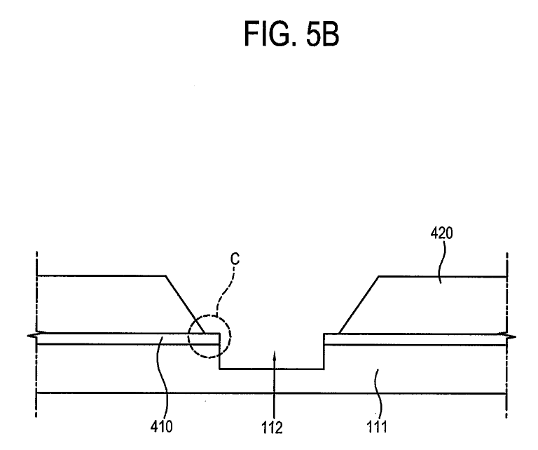

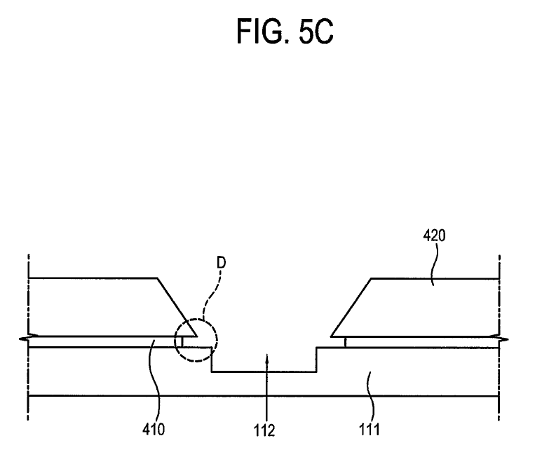

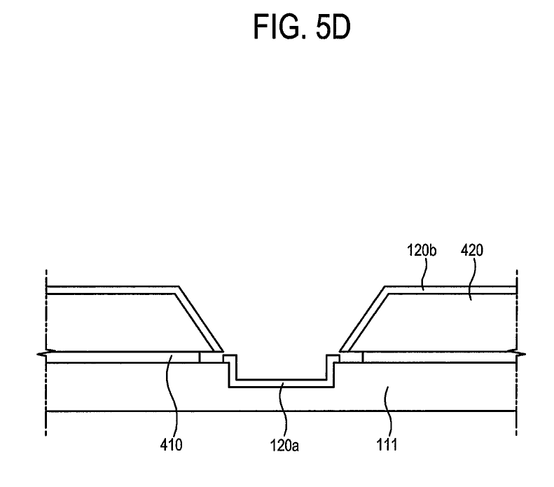

Next, a still another method of manufacturing the display device according to the first exemplary embodiment of the present invention will be described with reference to FIGS. 5A to 5D. It should be noted that the description will be made on different features from the method with reference to FIGS. 3A to 3H.

Referring to FIG. 5A, an auxiliary layer 410 is etched using a photoresist layer pattern 420. Etching of the auxiliary layer 410 is carried out by wet etching or dry etching.

Referring to FIG. 5B, a portion of an insulating substrate 111 not covered with the auxiliary layer 410 is etched to form a trench 112. In this process, the photoresist layer pattern 420 is partially damaged, but the auxiliary layer 410 is less damaged so that a portion of the auxiliary layer 410 is exposed outside the photoresist layer pattern 420 (see area C).

Whether the photoresist layer pattern 420 and the auxiliary layer 410 are damaged may be varied depending on their materials and etching conditions.

Referring to FIG. 5C, the auxiliary layer 410 is etched to form an undercut (area D) under the photoresist layer pattern 420. The undercut is securely formed under the photoresist layer pattern 420 by etching the auxiliary layer 410.

Referring to FIG. 5D, the seed layers 120a and 120b are formed. The seed layer 120b on the photoresist layer pattern 420 and the seed layer 120a in the trench 112 are separated from each other by the undercut.

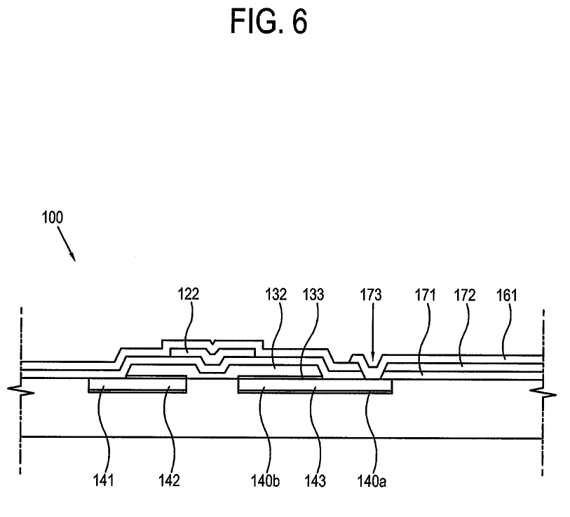

In the followings, a display device according to a second exemplary embodiment will be described with reference to FIG. 6. FIG. 6 illustrates only an area corresponding to the TFT in FIG. 2 without the second substrate 200 and the liquid crystal layer 300.

In the second exemplary embodiment, a data wiring 141, 142, and 143 is formed in a trench on an insulating substrate 111, and a TFT T has a top-gate type where a gate electrode 122 is formed on a semiconductor layer 132. The data wiring 141, 142, and 143 is made of a double layer of a lower seed layer 140a and an upper main wiring layer 140c.

According to the second embodiment, while the data wiring 141, 142, and 143 is formed to be thick, a gate wiring 121 and 122 formed thereon is prevented from being short-circuiting. Further, the data wiring 141, 142, and 143 may be decreased in thickness with low resistance maintained, thereby increasing an aperture ratio.

Unexplained parts are insulating layers 171 and 172 and a contact hole 173.

As described above, the present invention provides a method of manufacturing a display device having wiring with low resistance of which an upper wire is not disconnected and which does not cause the decrease of an aperture ratio.

Further, the present invention provides a display device having wiring with low resistance of which an upper wire is not disconnected and which does not cause the decrease of an aperture ratio.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of manufacturing a metal wiring comprising:
forming an auxiliary layer on an insulating substrate;
forming a photoresist layer pattern on the auxiliary layer, the photoresist layer partially exposing the auxiliary layer on the insulating substrate;
forming a trench in the insulating substrate by etching the exposed auxiliary layer and the insulating substrate under the exposed auxiliary layer;
forming a seed layer including a first seed layer disposed on the photoresist layer pattern and a second seed layer disposed in the trench;
removing the photoresist layer pattern and the first seed layer by lifting off the photoresist layer pattern;
removing the auxiliary layer remaining on the insulating substrate after lifting off the photoresist layer pattern; and
forming a main wiring layer on the second seed layer by electroless plating.

2. The method according to claim 1, wherein the auxiliary layer comprises at least one of molybdenum (Mo), a molybdenum alloy, chrome (Cr), copper (Cu), a copper alloy, aluminum (Al), an aluminum alloy, silver (Ag), a silver alloy an indium-tin-oxide and indium-zinc-oxide.

3. The method according to claim 2, wherein the auxiliary layer has a thickness of 50 Å to 3000 Å.

4. The method according to claim 2, wherein the seed layer comprises at least one of molybdenum (Mo), a molybdenum alloy, chrome (Cr), copper (Cu), a copper alloy, a copper oxide, aluminum (Al), an aluminum alloy, silver (Ag), a silver alloy, titanium (Ti), and a titanium alloy, wherein the seed layer has a etch selectivity with the auxiliary layer.

5. The method according to claim 4, wherein the main wiring layer comprises at least one of copper and silver.

6. The method according to claim 5, wherein the main wiring layer has a thickness of 0.3 μm to 2 μm.

7. The method according to claim 1, wherein the main wiring layer comprises at least one of copper and silver.

8. The method according to claim 7, wherein the main wiring layer has a thickness of 0.3 μm to 2 μm.

9. The method according to claim 1, forming a trech in the insulating substrate further comprises forming an undercut under the photoresist layer pattern.

10. The method according to claim 9, wherein the auxiliary layer comprises at least one of molybdenum (Mo), a molybdenum alloy, chrome (Cr), copper (Cu), a copper alloy, aluminum (Al), an aluminum alloy, silver (Ag), a silver alloy an indium-tin-oxide and indium-zinc-oxide.

11. The method according to claim 10, wherein the auxiliary layer has a thickness of 50 Å to 3000 Å.

12. The method according to claim 10, wherein the seed layer comprises at least one of molybdenum (Mo), a molybdenum alloy, chrome (Cr), copper (Cu), a copper alloy, a copper oxide, aluminum (Al), an aluminum alloy, silver (Ag), a silver alloy, titanium (Ti), and a titanium alloy, wherein the seed layer has a etch selectivity with the auxiliary layer.

13. The method according to claim 12, wherein the main wiring layer comprises at least one of copper and silver.

14. The method according to claim 13, wherein the main wiring layer has a thickness of 0.3 μm to 2 μm.

15. A wiring structure comprising:
an insulating substrate where a trench is formed; and
a wiring layer disposed in the trench including a copper oxide layer directly contacting with the insulating substrate and a copper layer disposed on the copper oxide layer.

16. The wiring structure according to claim 15, wherein the copper layer has a thickness of 0.3 μm to 2 μm.

17. The wiring structure according to claim 16, wherein the copper layer is disposed substantially in the trench.
